(19) United States
(12) Patent Application Publication
(10) Pub. No.: US 2009/0109708 A1
(43) Pub. Date: Apr. 30, 2009

(54) RADIANCE LIGHTING SYSTEM AND METHOD

(76) Inventor: TERRY HORWITZ, Garden Grove, CA (US)

Correspondence Address: SHIMOKAJI & ASSOCIATES, P.C., 8911 RESEARCH DRIVE, IRVINE, CA, 92618, US

(21) Appl. No.: 10/596,666

(22) PCT Filed: Oct. 6, 2005
(86) PCT No.: PCT/US05/36647

§ 371 Date: Jun. 20, 2006

Related U.S. Application Data
(60) Provisional application No. 60/617,289, filed on Oct. 8, 2004.

(51) Int. Cl. H01R 33/00

(52) U.S. Cl. 362/658; 362/640; 362/659

(57) ABSTRACT

A lighting system includes a wiring system and a plurality of light source modules adapted for connection to and disconnection from the wiring system Each light source module includes at least one light source unit including a plurality of light emitting diodes, wherein each of the light emitting diodes is independently connected with the wiring system The lighting system of the invention may be modular, allowing use of a suitable number and arrangement of light source modules for illuminating a given space or surface The lighting system may be adapted for being mounted, e g, to structures such as walls, ceilings, and the like, via a mounting assembly The lighting system may be suitable for, but not limited to, shedding visible light directly or indirectly to a space or a surface

### CROSS REFERENCE TO RELATED APPLICATIONS

The present application claims the benefit of the U.S. Provisional Application No. 60/617,289, filed Oct. 8, 2004.

### BACKGROUND OF THE INVENTION

The present invention generally relates to lighting systems and, more particularly, to a decorative lighting system and to a method for providing radiant illumination.

Light sources that include light emitting diodes (LEDs) are well known in the lighting industry. LEDs inherit a plurality of attributes, such as relatively high reliability, long operating lifetimes, relatively little power consumption, and relatively little heat generation, that make them desirable for many low voltage lighting applications. LEDs are typically arranged in arrays. In most lighting systems these arrays are electrically connected and need to be mounted to a surface. Lighting systems utilizing LEDs are used in decorative lighting applications to emphasize the features, for example, of a structure, a space, or a sign. A plurality of modular lighting systems using circuit board-mounted LEDs currently exist.

Prior art lighting systems include, for example, U.S. Pat. No. 6,793,369 B2 issued to Calzaretta et al., which discloses a light fixture where individual light sources are removably mounted in a strand of light sources. The fixture comprises a lens component and a base, the former supporting a strand of light sources (e.g., LEDs on a circuit board). The lens component and the base preferably interconnect via a sliding or snap-lock mechanism. The fixture can be mounted on a variety of surfaces such as stairs, walls, etc., via the base. Each light source includes preferably a high brightness LED having super yellow color and a water clear lens. Each of two light sources are electrically connected with each other via a wire assembly. The wire assembly connects to the light source via a connector, e.g., using tongue and groove components. However, it does not appear possible to connect or disconnect the light sources from the wire assembly without first removing the lens component from the base component. Furthermore, when one of the light sources included in a strand fails and needs to be replaced, this light source needs to be unplugged from the wire assembly, which breaks the electrical circuit and causes the entire lighting system to go out until the defective light source is replaced and connected to the wire assembly. Since each light source includes only one LED, the disclosed light fixture is a single color lighting system that does not appear to include color mixing possibilities.

Prior art lighting systems still further include, for example, U.S. Pat. No. 6,422,716 B2 and U.S. Patent Application No. 2001/0024368 A1 issued to Henrici et al. and assigned to BJB GmbH & Co. KG, which disclose an LED module comprised of a plastic base plate carrying surface-mount LEDs in an array. The insulating plate carries conductive traces to electrically interconnect cathodes and anodes of all the LEDs. Each LED module has a plurality of straight outer edges and the traces form a pair of contacts at a perpendicular centerline of each edge. The modules may be electrically and mechanically interconnected by clips comprising a dielectric base plate, a pair of conductors, and a dielectric cover. Apertures in the plate allow disassembly of an array to replace a defective module or reconfigure the array. However, no device for mounting the module to a structure appears to be disclosed. No wires are used to connect the modules, which makes it difficult to form a linear array over a long distance with this modular lighting system. Since the modules are electrically interconnected by clips, removing one module from the system, for example, to exchange it for another module will break the electrical circuit and will cause the entire system to fail until the new module is interconnected with the surrounding modules. Furthermore, it does not appear to be possible to easily remove and replace a module located in the center of the array. In order to exchange a module in the center of the array it may be necessary to remove several other modules to gain access to the module to be replaced.

Prior art lighting systems still further include, for example, U.S. Pat. No. 6,170,963 B1 issued to Arnold, which discloses a plurality of LED modules each including one LED, at least two electrical connectors attached to the LED, and a housing with first and second connective features so that when two LED modules are connected, the first connective feature of the LED module engages a second connective feature of another LED module, preventing relative motion there between. The plurality of modules may be assembled into an LED array, which may be connected to a circuit board via electrical connectors. Proper color balance can be achieved by intermixing LED modules of appropriate spectral content. It does not appear to be possible to change a color pattern or the intensity of a certain color. If one of the LED modules included in an LED array needs to be replaced, the entire array may need to be dissembled in order to have access to that module. Furthermore, it does not seem possible to remove one of the LED arrays without interrupting the electrical circuit of the LED array.

Prior art lighting systems still further include, for example, U.S. Patent Application No. 2004/0135522 A1 (Berman) which discloses a lighting module including three groups of LEDs, each of which generates light of a different color whose intensity can be controlled. In one version, the colors of the three groups are green (G), red (R) and blue (B), and the LEDs are physically arranged in a line in a repeating pattern, namely G_R_G_B_G_R_G_R (to give a 4:3:1 G:R:B ratio). In one embodiment, 192 LEDs are arranged linearly on a board having a length of 12.4 inches, comprising 96 green, 72 red, and 24 blue LEDs forming a lighting device. A lighting system can be formed by coupling multiple lighting devices to a central controller comprising an operator interface panel and an interface to an external computer. A user can select programs or modify the operation of the lighting system from the operator interface panel provided at the central controller. Procedures are provided for individually controlling and calibrating the color and power output of each lighting device. Combining such a high number of LEDs in one lighting device may be impractical for certain applications. The lighting system formed with the lighting devices is a system where the electrical circuit will be broken if one of the lighting devices is temporarily removed from the system, for example, to be replaced. If the lighting system is protected by a cover, this will need to be removed to allow access to the lighting devices, for example, to exchange one of the lighting devices.

As can be seen, there is a need for a lighting system that allows one to easily remove and exchange light source modules without interrupting the electrical operation of the remainder of the lighting system. Furthermore, there is a need for a lighting system that enables mixing the color and changing the intensity of the light provided by a light source without the need for sophisticated or intelligent computer control devices that are in common use today. Still further, there is a need for a lighting system that enables changing the color and/or the intensity of the light with off-shelf electrical switches and dimmers. Still further, there is a need for a lighting system that may provide indirect illumination of decorative elements, such as walls, ceilings, or other architectural details. There has still further arisen a need for a low voltage long linear lighting system that provides illumination in public spaces at low cost, that can easily be installed, and that provides long-term-usage and easy maintainability.

### SUMMARY OF THE INVENTION

In one aspect of the present invention, a lighting system comprises an electrically continuous wiring harness a connector unit electrically connected to the wiring harness; and a light source module electrically connected to the wiring harness via the connector unit; wherein the light source module may be disconnected from the connector unit in the absence of interrupting an electrical connection of the wiring harness.

In another aspect of the present invention, a lighting system comprises a wiring assembly including: an electrically continuous wiring harness; and a connector unit electrically connected to the wiring harness; and a first light source module electrically connected to the connector unit; wherein the first light source module can be removed from the connector unit in the absence of interrupting a continuous electrical connection of the wiring harness to a second light source module.

In a further aspect of the present invention, a lighting system for mounting to a surface comprises a wiring assembly including an electrically continuous wiring harness and a connector unit, the connector unit including a plurality of connection posts electrically coupled to the wiring harness; and a light source module removably connected with the wiring assembly, the light source module including a circuit board, the circuit board including openings for removable connection with the plurality of connection posts.

In a still further aspect of the present invention, a light source module for a lighting system comprises a housing adapted for removable modular connection with a wiring assembly, wherein at least a portion of the housing is transparent or translucent to visible light; a circuit board disposed within the housing, wherein the housing allows electrical connection of the circuit board with the wiring assembly; and a light source unit mounted on the circuit board, wherein the light source unit includes a plurality of light emitting diodes, wherein intensities of the light emitted by each of the light emitting diodes are controlled independently from each other.

In a still further aspect of the present invention, a wiring assembly for a lighting system comprises a electrically continuous wiring harness including a plurality of electrically continuous wires; and a plurality of connector units each including a plurality of connection posts providing electrical connection to the wires; wherein each of the connector units is adapted for receiving a light source module including a circuit board including a plurality of LEDs; and wherein the connection posts further provide electrical connection to the circuit board such that each of the LEDs can be controlled independently.

In a still further aspect of the present invention, a connector unit comprises a plurality of connection posts electrically connectable to a wiring harness of a lighting system; a wire control assembly top including a plurality of connector ports, wherein each of the connector ports receives one of the connection posts; and a wire control assembly bottom attachable to the wire control assembly top; wherein the connector unit is removably connectable to a light source module of the lighting system.

In a still further aspect of the present invention, a method for comprises the steps of: a) providing a lighting system including an electrically continuous wiring harness and a plurality of light source modules electrically connected with the wiring harness, wherein the light source module may be disconnected from the connector unit in the absence of interrupting an electrical connection of the wiring harness; b) positioning the lighting system with respect to the surface; and c) emitting light from the light source modules.

In a still further aspect of the present invention, a method of repairing a lighting system comprises the steps of: disconnecting a defective light source module from a connector unit electrically connected to a wiring harness, the step of disconnecting occurring in the absence of interrupting an electrical connection of the wiring harness; and connecting a working light source module with the connector unit in the absence of interrupting an electrical connection of the wiring harness.

These and other features, aspects and advantages of the present invention will become better understood with reference to the following drawings, description and claims.

### BRIEF DESCRIPTION OF THE DRAWINGS

FIG. 1 is a block diagram schematically representing a lighting system, according to one embodiment of the invention;

FIG. 2 is a block diagram schematically representing a light source module, according to another embodiment of the invention;

FIG. 3A is a plan view of a portion of a wiring assembly for a lighting system, according to another embodiment of the invention;

FIG. 3B is a plan view of a portion of a lighting system, according to another embodiment of the invention;

FIG. 3C is a plan view of a light source module, according to another embodiment of the invention;

FIG. 4A is an isometric view of a wiring assembly for a lighting system, according to another embodiment of the invention;

FIG. 4B is an exploded isometric view of the wiring assembly of FIG. 4A;

FIG. 5 is an exploded isometric view of a light source module for a lighting system, according to another embodiment of the invention;

FIG. 6A is an isometric view of a lighting system showing a partially assembled mounting assembly in relation to a wiring harness and a light source module, according to another embodiment of the invention;

FIG. 6B is an exploded isometric view of the lighting system of FIG. 6A;

FIG. 7 schematically represents a lighting system mounted to a separate structure, according to another embodiment of the invention; and

FIG. 8 schematically represents a series of steps involved in a method for lighting a space with a lighting system, according to another embodiment of the invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Broadly, the present invention provides a lighting system and methods for providing illumination. The present invention may be used to shed visible light to a spatial area, for example, theaters, passageways within public buildings, an interior space within a building or the like, or decorative elements, such as architectural details or signs. The present invention may be an indirect lighting system that may add light effects, such as a pleasing glow of it's surrounding atmosphere, to a wall application by providing a continuous linear stream of light.

When mounted high on a wall and directed upwards, the lighting system of the present invention may serve as an attractive decorative molding as well as a stylish light source with the glow of light reflection off a ceiling without creating a harsh glare. The lighting system of the present invention may further be mounted low on a wall and directed downward, creating an appealing contrast of light and shadow that will accent, for example, halls and corridors.

The lighting system of the present invention may be a low voltage radiance lighting system that has the ability to change the color of light and/or the intensity of light. The lighting system may be used to provide light of different colors by independently varying the intensities of any color frequency light emitted simultaneously from the light emitting diodes of any plurality of light source modules of the lighting system. The lighting system as in one embodiment of the present invention may provide a static wash of color by using only LEDs of one specific color and changing the intensity of this color. The lighting system as in one embodiment of the present invention may further provide controlled color mixing designs by including LEDs of various color frequencies in each lighting module and by individually controlling each of these LEDs. Independent control of each LED and individual circuit may be realized by means of common light dimmers and switches as opposed to DMX controllers, computers or chips typically used in the prior art. Furthermore, the lighting system as in one embodiment of the present invention may be used to provide back lighting for signs.

The lighting system of the invention may be modular, allowing use of a suitable number and arrangement of light source modules for illuminating a given space, such as passing areas, walls and ceilings, a structural architecture element, or a design element. The light source modules may be readily attached to, or detached from, an electrical wiring assembly for easy long-term maintenance. The lighting system of the invention may be adapted to fit into existing recesses or soffits and for being mounted to structures such as recesses, walls, ceilings, and the like, via a mounting assembly.

In contrast to conventional lighting systems of the prior art where a plurality of light sources, such as a strand of circuit boards including a plurality of LEDs, is typically covered with only one housing or lens element, the lighting system according to one embodiment of the present invention may include a plurality of self contained light source modules, wherein each light source module may be enclosed by a respective light source housing. Replacing a defective individual prior art light source, such as a single circuit board including a plurality of LEDs, typically requires removal of the housing or lens element covering the entire strand of circuit boards. Each light source module as in one embodiment of the present invention, which includes a circuit board including a plurality of LEDs enclosed by an individual housing, may be individually removed from the wiring assembly simply by unplugging or unsnapping the module from the wiring without effecting any other light source module of the lighting system. Then a new light source module may easily be inserted into the space of the removed module.

In one embodiment, the present invention provides a modular radiance lighting system that includes three main components for easy and low cost installation compared to prior art lighting systems where typically the entire operation of the lighting system is interrupted if one of the light sources fails or is removed from the system. The lighting system as in one embodiment of the present invention may include: one, a mounting assembly that may be attached to a structure in a desired location; two, a continuous wiring assembly that runs without interruptions throughout the entire lighting system, and that may include preinstalled connection posts at desired intervals, and that may be securely placed into the mounting assembly; and three, a plurality of individual light source modules that may be easily attached, mechanically and electrically, to the connection posts of the wiring assembly and that may be individually removed from the wiring assembly without interrupting the operation of the remaining modules in the lighting system. Thus, when one light source module fails to operate or needs to be removed or be replaced, the lighting system of the present invention will continue to operate. Furthermore, the connection posts of the wiring harness may be integrated into a connector unit that enables easy connection, mechanically and electrically, of a light source module to, or disconnection of a light source module from, the wiring harness, for example, by using a simple snap on mechanism. Consequently, it is possible to individually attach or release each light source module as in one embodiment of the present invention without taking the lighting system apart by, for example, removing a lens element or housing covering a plurality of light sources, as necessary with prior art lighting systems.

In further contrast to the prior art where groups of LEDs are powered individually, the present invention provides a wiring assembly that includes a plurality of separate electrical circuits that allows individual power to each of a plurality of LEDs in a group. By individually controlling each of the LEDs, the lighting system as in one embodiment of the present invention may provide a static wash of color by varying the intensity of the light emitted by the LEDs where the LEDs emit light of the same color. Furthermore, by individually controlling each of the LEDs included in a light source unit, the lighting system as in one embodiment of the present invention may provide controlled color mixing designs where each of the LEDs provides light of a different color. In contrast to linearly arranged LEDs in prior art lighting systems, the lighting system of the present invention includes the LEDs arranged in a cluster to provide different color groupings depending on the precision of color and range of colors desired.

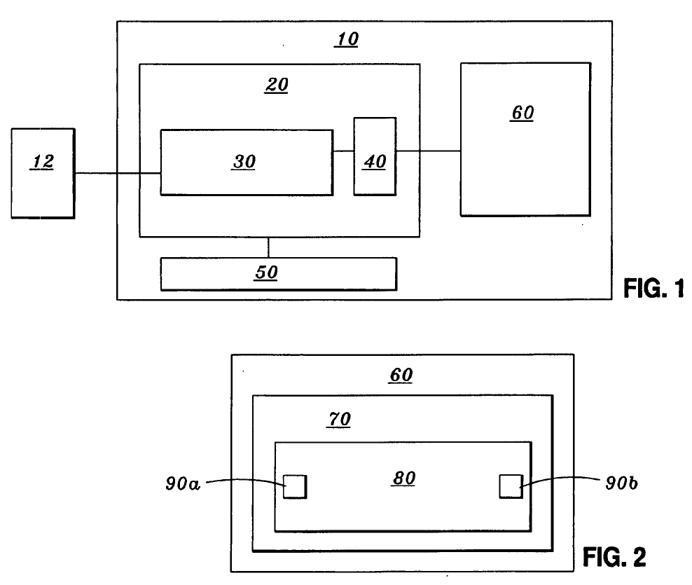

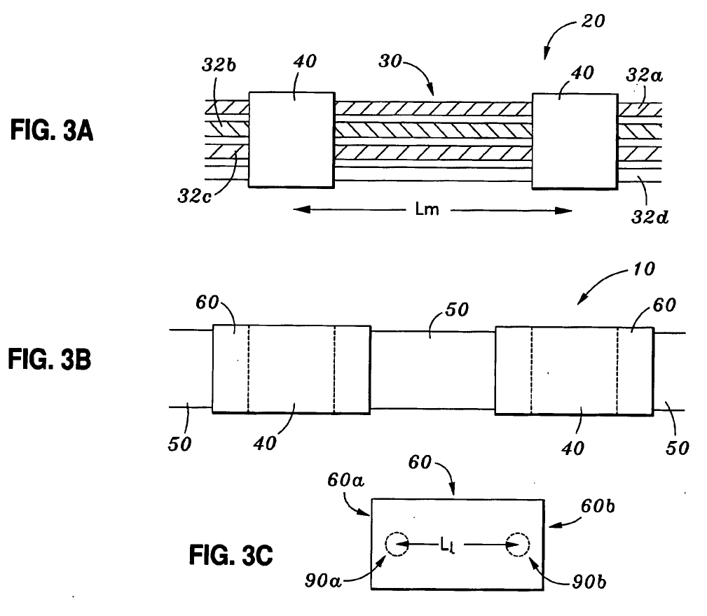

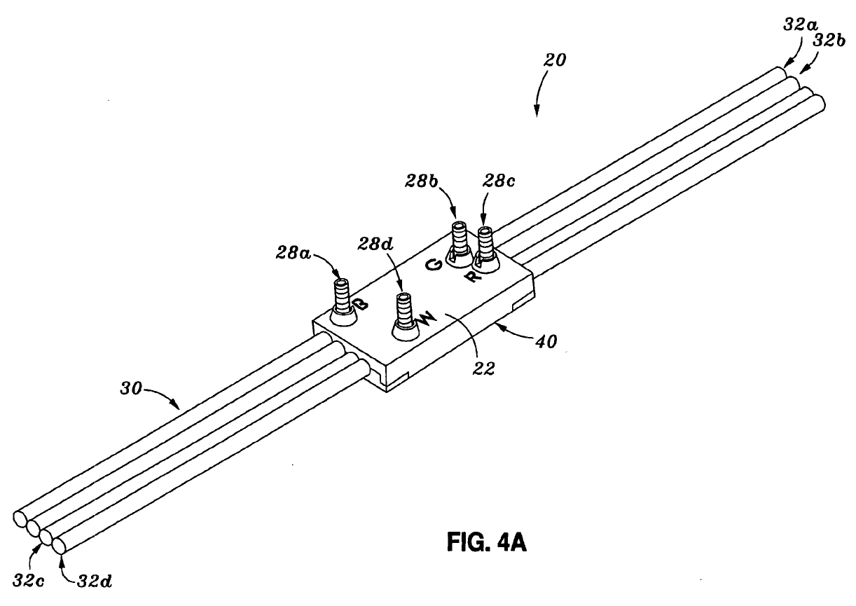

FIG. 1 is a block diagram schematically representing a lighting system 10, according to one embodiment of the invention. Lighting system 10 may comprise a wiring assembly 20 including an electrically continuous and, therefore, electrically uninterrupted wiring harness 30 electrically coupled to one or more connector units 40, such as shown in FIGS. 3A, 4A, 6A, and 6B. The reference to “continuous” is intended to refer to an uninterrupted electrical condition or an absence of breaks in electrical connection. Lighting system 10 may further comprise one or more light source modules 60 (such as that described below in reference to FIG. 2) coupled to one or more connector units 40, whereby each light source module 60 may be electrically coupled to wiring harness 30 through one of the connector units 40.

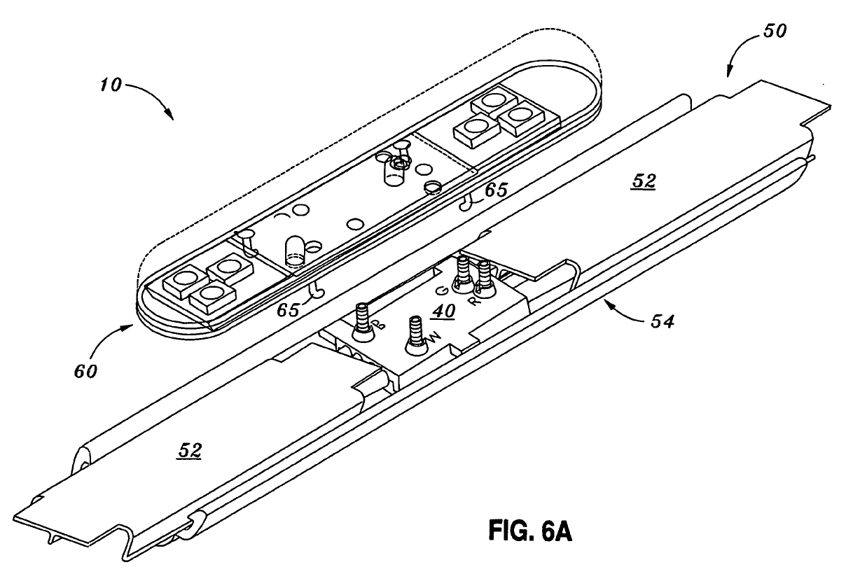

Lighting system 10 may still further comprise a mounting assembly 50, such as that described below in reference to FIGS. 6A and 6B, adapted for at least partially enclosing or containing wiring assembly 20. In some embodiments, mounting assembly 50 may be further adapted, such as by providing a mounting base 54 (as shown in FIGS. 6A and 6B), for mounting wiring assembly 20 and light source modules 60 to a separate structure, e.g., a wall (see, for example, FIGS. 6A-B and 7).

Again with reference to FIG. 1, lighting system 10 may be coupled to a power supply 12 for providing electrical power to lighting system 10. Power supply 12 may be adapted to provide a voltage, for example, about 12 volts or 24 volts, to lighting system 10. Power supply 12 may comprise, for example, a transformer. Current provided from power supply 12 may be AC or DC. Lighting system 10 may comprise parallel wiring utilizing Class II (according to UL 1310, the Standard for Safety of Class 2 Power Units) power supply, which allows each light source to operate independently, providing superior safety and ease of maintenance.

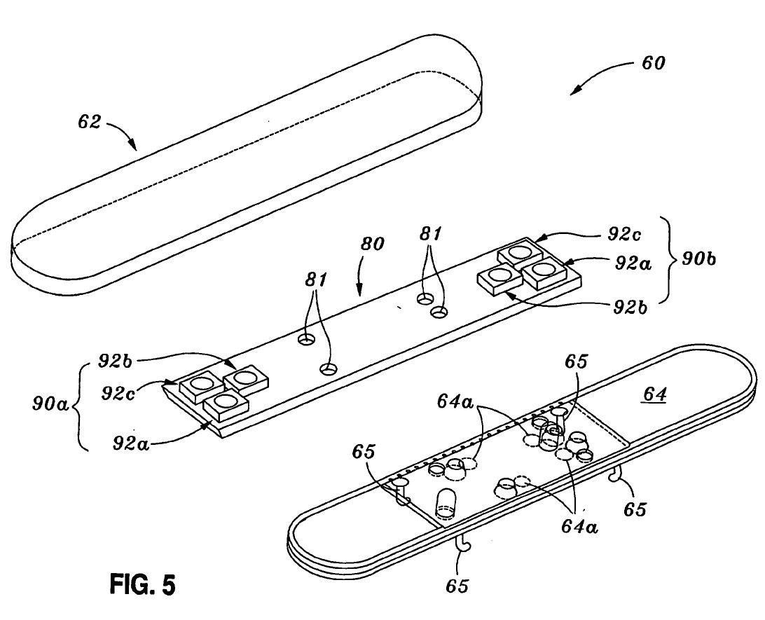

FIG. 2 is a block diagram schematically representing a light source module 60, which may be used as a component of lighting system 10, according to another embodiment of the invention. Light source module 60 may comprise a light source housing 70 and at least one circuit board 80 disposed within housing 70. Circuit board 80 may include at least a first light source unit 90a and a second light source unit 90b. First and second light source units 90a, 90b may be disposed at opposing ends of circuit board 80. The first light source unit 90a may comprise a plurality of light emitting diodes (LEDs) (such as 92a, 92b, and 92c, shown in FIG. 5) and the second light source unit 90b may also comprise a plurality of LEDs (such as 92a, 92b, and 92c, shown in FIG. 5). Various LEDs which emit light of various wavelengths within the visible region of the electromagnetic spectrum, which may correspond to various colors (e.g., red, green, blue), are well known in the art.

FIG. 3A is a plan view of a portion of a wiring assembly 20 for a lighting system 10, according to another embodiment of the invention. Wiring assembly 20 may comprise an electrically continuous and, therefore, electrically uninterrupted wiring harness 30, which may comprise a plurality of electrically continuous wires, such as a plurality of uninterrupted strands of conductive wire. As shown, wiring harness 30 may comprise first, second, and third wires 32a, 32b, 32c, respectively. Wiring harness 30 may further comprise a fourth wire 32d. Fourth wire 32d may be a common wire, and fourth wire 32d may be colored white. First, second, and third wires 32a-c, may be colored blue, green, and red, respectively, for easy identification. First, second, and third wires 32a-c, may, in combination with the common fourth wire 32d, provide three separate circuits within lighting system 10. The number of wires may depend on the number of LEDs included in the light source unit, such as light source unit 90a, shown in FIG. 5. The wiring assembly 20 can include one wire for each LED included in the light source unit in addition to the common wire 32d. It may be possible to design the light source 10 to include only one, or two, or three, or more separate circuits.

First, second, and third wires 32a-c, may respectively be independently connected with a plurality of first LEDs (such as 29a), second LEDs (such as 29b), and third LEDs (such as 29c) and may in combination with the common fourth wire 32d respectively provide power, for example, to any plurality of LEDs of any color frequency (see, for example, FIG. 5). Consequently, all LEDs connected to the first wire 32a may be controlled independently from the LEDs connected to the second wire 32b and to the third wire 32c. LEDs connected to the second wire 32b may be controlled independently from the LEDs connected to the first wire 32a and to the third wire 32c. LEDs connected to the third wire 32c may be controlled independently from the LEDs connected to the first wire 32a and to the second wire 32b. Therefore, the intensity of the light emitted by the LEDs connected to the first wire 32a, to the second wire 32b, and to the third wire 32c may be controlled independently from each other. By such independent control, different color shades and intensities of light may be produced as further described below.

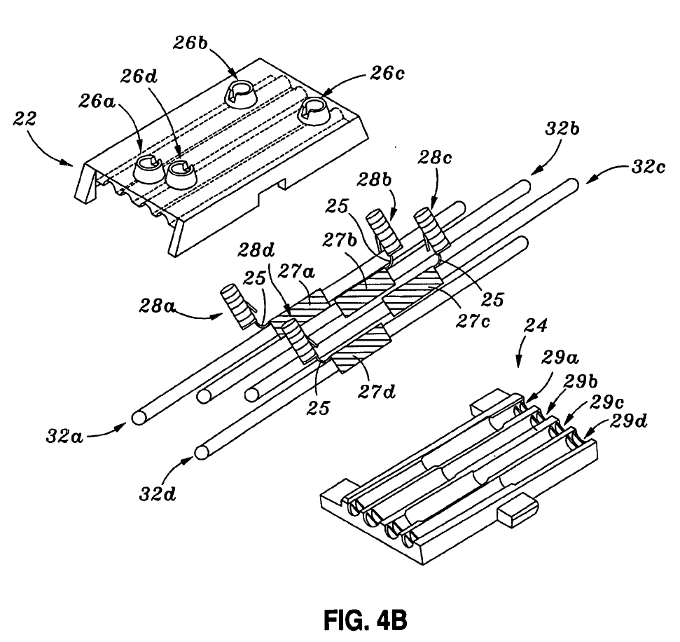

Again with reference to FIG. 3A, wiring assembly 20 may further comprise a plurality of connector units 40 shown in detail in FIGS. 4a and 4b. Connector units 40 may be spaced apart from each other on wiring harness 30, e.g., in the form of a linear array. In some embodiments, connector units 40 may be spaced equidistant from each other by a distance, Lₘ typically in the range of from about 2 to 12 inches, and usually with a spacing of about 6 inches.

FIG. 3B is a plan view of a portion of a lighting system 10, according to another embodiment of the invention. Lighting system 10 may comprise a plurality of light source modules 60. Each light source module 60 may be electrically coupled to the wiring harness 30 via one of the connector units 40 through a modular connection. In other words, it may be possible to assemble the lighting system 10 simply by connecting pre-fabricated modules, such as the connector unit 40 and the light source module 60 (see, for example, FIGS. 3A-C). The first, second, third, and fourth connection posts 28a-d (see, for example, FIG. 4B) may provide electrical connection between the wires 32a-d of the wiring harness 30 and the light source module 60 (see, for example FIGS. 5 and 6A). Light source module 60 may be removably connected to connector unit 40, for example, by using a snap-on mechanism utilizing connection feet 65 (see, for example, FIGS. 5, 6A, and 6B) or plug-in mechanism (not shown). No tools may be required to connect the light source module 60 with the connector unit 40 or disconnect it from the connector unit 40. Light source module 60 may be connected to, or disconnected from, the connector unit 40 in an easy and simple manual operation, such as pushing the connection feet 65 of the light source module 60 into the wiring assembly 20 or pulling the connection feet 65 of the light source module 60 out from the wiring assembly 20 while disabling a locking mechanism of the connection feet 65.

Again with reference to FIG. 3B, lighting system 10 may further comprise a mounting assembly 50. Mounting assembly 50 may be adapted for mounting lighting system 10 to a structure, for example, a wall, floor, or ceiling of a building or other space to be illuminated (see, for example, FIGS. 6A-B, 7). Mounting assembly 50 may be adapted for enclosing or containing wiring system 20. The wiring harness 30 as well as the connector units 40 may be easily, for example, without the need to use tools or difficult and time consuming operations, placed into or removed from the mounting assembly 50, for example, by simply snapping the wiring system 20 into the mounting base 54 of the mounting assembly 50 that may be already mounted to a surface in a desired location, such as a wall or a recess. Extruded profiles of different shapes of the mounting base 54 may be used in the mounting assembly 50. The lighting system 10 may be mounted to a surface to provide a direct or an indirect lighting effect with respect to the surface. For example, the mounting base 54 may be mounted within a cove or a recessed area such that a surface above or across the cove or recessed area may be indirectly illuminated with the lighting system 10.

FIG. 3C is a plan view of a light source module 60, according to one aspect of the present invention. Light source module 60 may include, for example, a pair of light source units, namely first light source unit 90a and second light source unit 90b disposed at a first end 60a and a second end 60b, respectively, of light source module 60. First and second light source units 90a, 90b may be spaced apart by a distance Lt, wherein L_{L} may typically be in the range of from about 1.0 to 6.0 inches, and usually about 3 inches. Lₘ may be spaced apart by a range of 2 to 12 inches usually about 6 inches. In some embodiments, where distance Lₘ is about 6 inches (FIG. 3A), and distance L_{L} is about 3 inches, the spacing between each second light source unit 90b and the first light source unit 90a of the adjacent light source module 60 is also about 3 inches. Thus, a plurality of light source units 90a, 90b may be spaced about 3 inches apart. Lighting system 10 may extend over a distance of several feet or several yards; accordingly, lighting system 10 may include several dozen or more light source units 90a, 90b.

FIG. 4A is an isometric view of a wiring assembly 20 for a lighting system 10, and FIG. 4B is an exploded isometric view of the wiring assembly 20 of FIG. 4A, according to another embodiment of the invention. Wiring assembly 20 may include a connector unit 40 electrically coupled to first, second, third, and fourth wires 32a-d, generally as described hereinabove with respect to FIG. 3A. Connector unit 40 may comprise a wire control assembly top 22 and a wire control assembly bottom 24 attachable to wire control assembly top 22.

With reference to FIG. 4B, wire control assembly top 22 may include a first, second, third, and fourth connector port 26a, 26b, 26c, and 26d, respectively. First, second, third, and fourth connector ports 26a-d may be adapted for receiving first, second, third, and fourth connection posts 28a, 28b, 28c, and 28d, respectively. First, second, third, and fourth connection posts 28a-d may be electrically coupled, as described below, to first, second, third, and fourth wires 32a-d, respectively. The connection posts 28a-d may be positioned, for example, perpendicular with respect to the wires 32a-d. The connection posts 28a-d may be positioned to make good electrical contact with the wires 32a-d and the circuit board 80. Light source module 60 may be readily electrically coupled to first, second, third, and fourth wires 32a-d via first, second, third, and fourth connection posts 28a-d, respectively (see also FIG. 6A). When light source module 60 is connected with the connector unit 40 the connection posts 28a-d that are electrically coupled with the wires 32a-d, respectively, will also make contact with a circuit board 80 (see, for example, FIG. 5) and, therefore, provide electrical connection between the circuit board 80 and the wires 32a-d. First, second, third, and fourth wires 32a-d may each comprise insulated copper wire, e.g., braided wire.

In some embodiments, first, second, third, and fourth connection posts 28a-d may be coupled to first, second, third, and fourth wires 32a-d, respectively, via a metal spike or tongue (not shown) which penetrates and makes electrical contact with the braided copper. For example, each of first, second, third, and fourth connection posts 28a-d may extend into a sharp spike adapted for insertion into first, second, third, and fourth wires 32a-d to provide electrical coupling of first, second, third, and fourth connection posts 28a-d to first, second, third, and fourth wires 32a-d, respectively.

In the embodiment shown in FIG. 4B, a connection post extension 25 may extend each of first, second, third, and fourth connection posts 28a-d to make them longer. The connection post extensions 25 may be made out of a conductive material and may have a cross-section that is smaller than the cross-section of the connection posts 28a-d, as shown in FIG. 4B. The connection post extensions 25 may be, for example, wires or metal bands. The connection post extension 25 of the first, second, third, and fourth connection posts 28a-d may be connected via a first, second, third, and fourth sleeve 27a-d, respectively, to the first, second, third, and fourth wires 32a-d, respectively. First, second, third, and fourth sleeves 27a-d may be retained around each connection post extension 25. Consequently, the first, second, third, and fourth connection posts 28a-d may be mechanically affixed and electrically connected with first, second, third, and fourth wires 32a-d via the connection post extension 25. The wires 32a-d may be electrically continuous and, therefore, electrically uninterrupted strands of electrical wire that extend throughout the entire lighting system 10.

Wire control assembly bottom 24 may include first, second, third, and fourth grooves 29a-d for accommodating first, second, third, and fourth wires 32a-d, respectively. Wire control assembly top 22 may have an analogous set of grooves (not shown). The wire control assembly top 22 may be attachable to the wire control assembly bottom 24, for example, by using a snap-on mechanism. The wire control assembly top 22 may further be permanently molded together with the wire control assembly bottom 24 prior to inserting the wiring assembly 20 into the mounting assembly 50.

FIG. 5 is an exploded isometric view of a light source module 60 for a lighting system 10, according to another embodiment of the invention. Light source module 60 may comprise a light source cover 62 and a light source base 64. Light source cover 62 and light source base 64 may be permanently attached to provide a housing 70 (see, for example, FIG. 2) for accommodating circuit board 80 that may protect the circuit board 80 and the light source units 90a and 90b, for example from weather or tampering. Light source cover 62 and light source base 64 may also be adapted to attach to each other, for example, by snapping light source cover 62 onto the light source base 64, to provide a housing 70 (see, for example, FIG. 2) for accommodating circuit board 80. Consequently, the lighting system 10 may be used as an indoor and as an outdoor product. Typically, at least a portion of light source cover 62 may be transparent or translucent to visible light. In some embodiments, light source cover 62 may be transparent to visible light in its entirety. Light source cover 62 may comprise a colorless, transparent plastic, such as a polycarbonate, and the like. Light source base 64 may include four openings 64a for receiving first, second, third, and fourth connection posts 28a-d (see, for example, FIGS. 4A-B). Light source base 64 may further include connection feet 65 that enable connecting the light source module with the connector unit 40 via a snap-on mechanism.

Still referring to FIG. 5, circuit board 80 may comprise a first light source unit 90a and a second light source unit 90b. Circuit board 80 may further include four openings 81 for receiving first, second, third, and fourth connection posts 28a-d (see, for example, FIGS. 4A-B). The connection posts 28a-d electrically couple the circuit board 80 with the wiring harness 30. Each light source unit 90a and 90b may represent a color grouping, which may be identical or different, depending on the precision of color and range of colors desired. Each light source unit 90a, 90b may comprise a plurality of LEDs (light emitting diodes), such as a first, second, and third LEDs 92a, 92b, 92c, respectively. First, second, and third LEDs 92a-c may be disposed on circuit board 80 to form a cluster. For example, LEDs 92a-c may be arranged in a triangular configuration as illustrated in FIG. 5. First, second, and third LEDs 92a-c may comprise LEDs emitting light of the same or different color. For example, first, second, and third LEDs 92a-c may respectively comprise a blue LED, a green LED, and a red LED. By independently varying the intensities of the red, green, and blue LEDs, an indefinite number of colors may be produced.

In another application, it may be desired that light source units 90a and 90b each includes a cluster of one red LED, one white LED, and one orange LED to create an indefinite number of shades of red by varying the intensities of the light emitted from the first, second, and third LEDs 92a-c, which might not be produced by the standard use of red, green, and blue color mixing.

In another example, first, second, and third LEDs 92a-c of the first light source unit 90a may comprise two white LEDs and one red LED while the first, second, and third LEDs 92a-c of the second light source unit 90b may comprise two white LEDs and one yellow LEDs. By independently varying the intensities of the light emitted from the first, second, and third LEDs 92a-c, an indefinite number of shades of white light may be produced mimicking many incandescent light sources.

Typically, the circuit board 80 may include the first light source unit 90a and the second light source unit 90b, but it may also be possible to include only one light source units 90a or 90b in the circuit board 80. While typically three LEDs, such as 92a-c (FIG. 5) are included in each of the light source units 90a and 90b, it may be possible to include less or more than three LEDs in each of the light source units 90a and 90b.

By providing a light source module 60 that includes at least one cluster of LEDs, such as LEDs 92a-c (FIG. 5), and by providing the possibility to individually control the intensity of each of the LEDs 92a-c (as described below) the lighting system 10 may create specific shades of light dependent on the application needs. While the lighting system 10 may be used to easily mix and change colors, it may also be used to easily change the shade or intensity of a single color.

FIG. 6A is an isometric view of a lighting system 10 including a partially assembled mounting assembly 50, wherein mounting assembly 50 is shown in relation to a wiring harness 30 and a light source module 60 of lighting system 10, according to another embodiment of the invention. FIG. 6B is an exploded isometric view of the lighting system 10 of FIG. 6A. Mounting assembly 50 may comprise a wire cover 52 and a mounting base 54. Wire cover 52 and mounting base 54 may be adapted such that wire cover 52 can readily be attached to mounting base 54; for example, wire cover 52 may be adapted to snap into affixed relationship with respect to mounting base 54. Wire cover 52 may be adapted to completely enclose first, second, third, and fourth wires 32a-d of wiring harness 30. Wire cover 52 may further be adapted to secure the wires 32a-d of the wiring harness 30 to the mounting base 54. Wire cover 52 and mounting base 54 may each comprise a durable plastic, such as PVC, and the like. Such plastics are well known in the art.

The mounting base 54 may further be a linear plastic extrusion that may be mounted to a surface, such as a wall, ceiling, column, recess or other architectural structure, using, for example, screws 55 as shown in FIG. 6B. Extruded profiles of different shapes of the mounting base 54 may be used in the mounting assembly 50. The lighting system 10 may be mounted to a surface to provide a direct or an indirect lighting effect with respect to the surface. It may further be possible to design the mounting base 54 to have a shape, such as a decorative spiral.

Light source module 60 may be attached to the connector unit 40 after the wiring assembly 20 (FIG. 4A) is inserted into the mounting base 54. The light source module 60 may be removably connected with the connector unit 40 using, for example, a snap-on (FIG. 6A) or a plug-in mechanism.

Since the wiring system 20 includes wiring harness 30 that includes continuously linear extending wires, such as wires 32a-d (FIG. 4B) as well as a plurality of connector units 40 that provide electrical connection to the wires 32a-d and that are connected with the wiring harness 30, the electrical circuit of the lighting system 10 will not be electrically interrupted or disconnected when one or more light source modules 60 are removed from the system 10, for example, to be replaced. The connector units 40 may be connected with the wiring harness 30 by electrically connecting connection posts 28a-d of the connector unit 40 to the wires 32a-d of the wiring harness 30 at desired intervals. When the light source module 60 is attached to the connector unit 40, the connection posts 28a-d (see, for example, FIG. 4A) may make contact with the circuit board 80, for example, by penetrating and physically touching the bores 81, to provide electrical contact between the wiring harness 30 and the circuit board 80. The circuit board 80 may be designed such that each LED 92a is connected with the wire 32a, that each LED 92b is connected with the wire 32b, that each LED 92c is connected with the wire 32c, and such that the LEDs 92a-c are connected with the common wire 32d. This configuration may enable individual control of the intensity of the light emitted from the LEDs 92a-c.

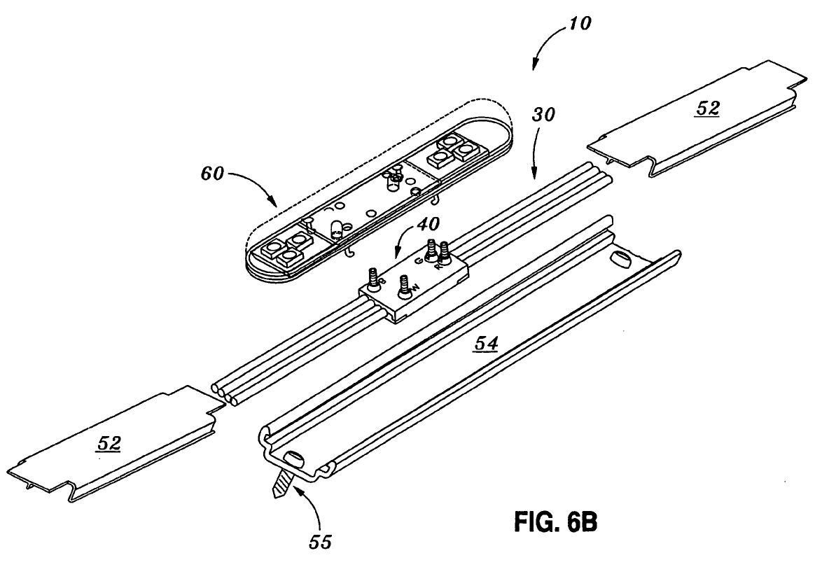

Mounting assembly 50 may be adapted for convenient attachment to a separate structure 14 (see, for example, FIG. 7). Various suitable attachment means, including hooks, screws, adhesives, hook and loop fasteners (e.g., Velcro™), adhesive tape, and the like, may be used to mount lighting system 10 to separate structure 14. Although a screw 55 is shown in FIG. 6B, it is to be understood that the invention is not limited to attachment of mounting assembly 50 via screws 55. Structure 14 may comprise, as an example, a wall, a ceiling, a floor, and the like. However, it is to be understood that the invention is not limited to attachment of lighting system 10 to a separate structure.

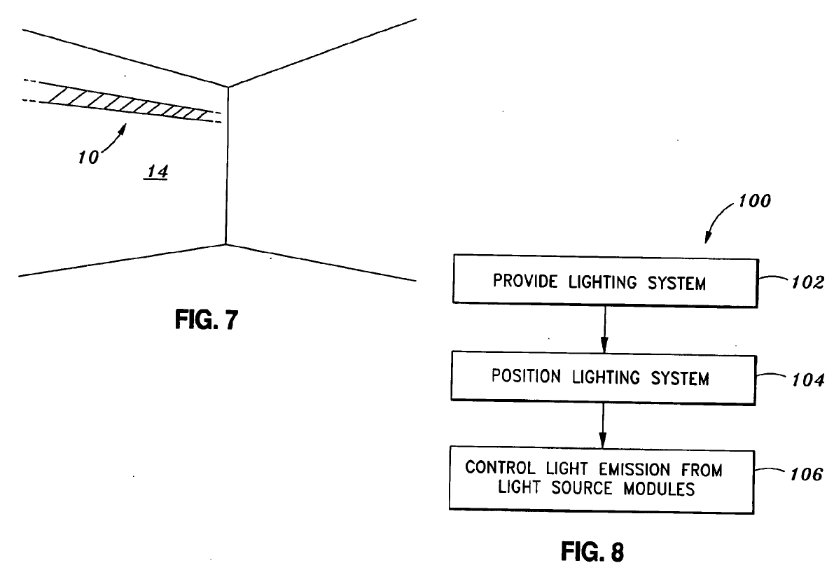

FIG. 8 schematically represents a series of steps involved in a method 100 for lighting a space with a lighting system, according to another embodiment of the invention, wherein step 102 may involve providing a lighting system of the present invention. The lighting system provided in step 102 may have various elements, features, and characteristics as described hereinabove for lighting system 10 with respect to FIGS. 1-7.

Step 104 may involve positioning the lighting system provided in prior step 102. Step 104 may involve positioning the lighting system adjacent to, or in at least close proximity to, a space to be illuminated by the lighting system. In some embodiments, step 104 may involve mounting the lighting system to a separate structure, wherein the structure may comprise a wall, a ceiling, or the like, and wherein the structure may be within a building.

Step 106 may involve controlling light emission from one or more light source modules of the lighting system. Typically, step 106 may involve emitting light simultaneously from a plurality of light source modules, wherein the light source modules may have various elements, features, and characteristics as described hereinabove for light source module 60, e.g., with respect to FIGS. 2 and 5. Step 106 may involve independently controlling the relative intensity of light emitted from differently colored LEDs, e.g., the color frequency of any LED may be combined with any other LED to provide light emission of a desired color and intensity.

It should be understood, of course, that the foregoing relates to exemplary embodiments of the invention and that modifications may be made without departing from the spirit and scope of the invention as set forth in the following claims.

1. A lighting system, comprising:
an electrically continuous wiring harness having a plurality of separate electrical circuits;
a connector unit electrically connected to said wiring harness; and
a light source module electrically connected to each of said plurality of separate electrical circuits in said wiring harness via said connector unit, wherein each of said plurality of separate electrical circuits are arranged to independently provide power to the light source module;
wherein said light source module may he disconnected from said connector unit in the absence of interrupting an electrical connection of said wiring harness.

2. The lighting system of claim 1, wherein said wiring harness includes a plurality of electrically continuous wires.

3. The lighting system of claim 1, wherein said connector unit includes a plurality of connection posts providing electrical connection to said wires.

4. The lighting system of claim 1, wherein said light source module includes at least one light emitting diode.

5. The lighting system of claim 1, further including at least one additional connector unit.

6. The lighting system of claim 1, further including at least one additional light source module.

7. A lighting system, comprising:
a wiring assembly including:
an electrically continuous wiring harness having a plurality of separate electrical circuits; and
a connector unit electrically connected to said wiring harness; and
a first light source module electrically connected to said connector unit, wherein each of said plurality of separate electrical circuits in the wiring harness are arranged to independently provide power to the light source module via said connector unit;
wherein said first light source module can be removed from said connector unit in the absence of interrupting a continuous electrical connection of said wiring harness to a second light source module.

8. The lighting system of claim 7, wherein said wiring assembly includes at least one additional connector unit electrically coupled to said wiring harness.

9. The lighting system of claim 7, wherein said first light source module is electrically connected with said wiring harness via said connector unit.

10. The lighting system of claim 7, wherein said wiring harness includes a plurality of electrically continuous wires.

11. The lighting system of claim 10, wherein said wires provide the plurality of separate circuits within said lighting system.

12. The lighting system of claim 10, wherein said connector unit includes a plurality of connection posts, wherein each of said connection posts is electrically coupled to said wires.

13. The lighting system of claim 7, wherein said first light source module includes at least one light source unit mounted on a circuit board, wherein said light source unit includes a plurality of light emitting diodes arranged in a cluster.

14. The lighting system of claim 13 wherein said light emitting diodes emit light of the same color.

15. The lighting system of claim 13, wherein each of said light emitting diodes emits light of a different color.

16. The lighting system of claim 13, wherein said light source module includes a light source cover and a light source base adapted to provide a housing for accommodating said circuit board.

17. The lighting system of claim 16, wherein said light source cover and said light source base are permanently molded together.

18. The lighting system of claim 7, further including a mounting assembly adapted for mounting said wiring assembly to a structure.

19. A lighting system for mounting to a surface, comprising:
a wiring assembly including an electrically continuous wiring harness and a connector unit,
said connector unit including a plurality of connection posts electrically coupled to said wiring harness; and
a light source module removably connected with said wiring assembly, said light source module including a circuit board having a plurality of light emitting diodes arranged in a cluster, wherein each of said plurality of light emitting diodes are arranged to independently receive power from different portions of the wiring assembly,
said circuit board including openings for removable connection with said plurality of connection posts.

20. The lighting system of claim 19, further including a mounting assembly including a mounting base and a wire cover, wherein:
said mounting base is attached to said surface,
said mounting base receives and secures said wiring assembly, and
said wire cover is attached to said mounting base to enclose said wiring harness.

21. The lighting system of claim 20, wherein said mounting base comprises a linear plastic extrusion.

22. The lighting system of claim 20, wherein said wire cover is removably attached to said mounting base covering said wiring harness.

23. The lighting system of claim 19, wherein said wiring harness includes a first electrically continuous wire, a second electrically continuous wire, a third electrically continuous wire, and a common electrical continuous wire.

24. The lighting system of claim 23, wherein said first, second, third, and common wires are color-coded.

25. The lighting system of claim 19, wherein said connector unit includes:
a first connection post electrically coupled to said first wire,
a second connection post electrically coupled to said second wire,
a third connection post electrically coupled to said third wire, and
a fourth connection post electrically coupled to said common wire.

26. The lighting system of claim 19, wherein:
said circuit board of said light source module includes a first light source unit, and
said first light source unit includes a first light emitting diode, a second light emitting diode, and a third light emitting diode arranged in a cluster on said circuit board.

27. The lighting system of claim 26, wherein:
said first light emitting diode is electrically coupled to said first wire via said first connection post,
said second light emitting diode is electrically coupled to said second wire via said second connection post,
said third light emitting diode is electrically coupled to said third wire via said third connection post, and
said first, second and third light emitting diodes are electrically coupled with said common wire via said fourth connection post.

28. The lighting system of claim 26, wherein the intensity of light emitted from said first, second, and third light emitting diodes is controlled independently.

29. The lighting system of claim 28, wherein:
said first light emitting diode emits light having a first color frequency,
said second light emitting diode emits light having a second color frequency, and
said third light emitting diode emits light having a third color frequency.

30. The lighting system of claim 19, further including at least one additional connector unit and at least one additional light source module connected with said additional connector unit.

31. The lighting system of claim 30, wherein said connector units are spaced apart from each other by about 6 inches.

32. The lighting system of claim 19, wherein said connector unit includes a wire control assembly top and a wire control assembly bottom, wherein said wire control assembly top includes a plurality of connector ports each adapted for receiving one of said connection posts.

33. The lighting system of claim 19, wherein said light source module includes a second light source unit.

34. A light source module for a lighting system, comprising:
a housing adapted for removable modular connection with a wiring assembly, wherein at least a portion of said housing is transparent or translucent to visible light;
a circuit board disposed within said housing, wherein said housing allows electrical connection of said circuit board with said wiring assembly; and
a light source unit mounted on said circuit board, wherein said light source unit includes a plurality of light emitting diodes, wherein intensities of the light emitted by each of said light emitting diodes are controlled independently from each other.

35. The light source module of claim 34, including at least one additional light source unit mounted on said circuit board, wherein said additional light source unit includes a plurality of light emitting diodes.

36. The light source module of claim 34, wherein said light source unit includes a first light emitting diode, a second light emitting diode, and a third light emitting diode.

37. The light source module of claim 36, wherein:
said first light emitting diode emits light of a white color,
said second light emitting diode emits light of a orange color, and
said third light emitting diode emits light of a red color.

38. The light source module of claim 36, wherein said first light emitting diode, said second light emitting diode, and said third light emitting diode emit light of the same color.

39. The light source module of claim 36, wherein said first light emitting diode, said second light emitting diode, and said third light emitting diode are disposed on said circuit board in a cluster configuration.

40. The light source module of claim 34, wherein said housing includes a light source cover and a light source base adapted to attach to each other and accommodate said circuit board.

41. The light source module of claim 40, wherein said light source cover and said light source base are permanently attached to each other.

42. The light source module of claim 40, wherein said light source base and said circuit board are adapted for mechanical and electrical connection to and disconnection from a wiring assembly.

43. A wiring assembly for a lighting system, comprising:
a electrically continuous wiring harness including a plurality of electrically continuous wires; and
a plurality of connector units each including a plurality of connection posts providing electrical connection to said wires;
wherein each of said connector units is adapted for receiving a light source module including a circuit board including a plurality of LEDs; and
wherein said connection posts further provide electrical connection to said circuit board such that each of said LEDs can be controlled independently.

44. The wiring assembly of claim 43, wherein said wires form a plurality of separate circuits.

45. The wiring assembly of claim 43, wherein said connector units are spaced apart on said wiring harness.

46. The wiring assembly of claim 43, wherein said wires are color coded.

47. The wiring assembly of claim 43, said connector unit includes a wire control assembly top and a wire control assembly bottom attachable to said wire control assembly top.

48. The wiring assembly of claim 47, wherein said wire control assembly top includes a plurality of connector ports each adapted for receiving one of said connection posts.

49. The wiring assembly of claim 47, wherein said wire control assembly top and said wire control assembly bottom include a plurality of analogous grooved adapted for receiving said wires.

50. The wiring assembly of claim 43, wherein each of said connection posts includes a connection post extension adapted for making electrical contact with one of said wires.

51. A connector unit, comprising:
a plurality of connection posts electrically connectable to a plurality of separate electrical circuits in a wiring harness of a lighting system;
a wire control assembly top including a plurality of connector ports, wherein each of said connector ports receives one of said connection posts; and
a wire control assembly bottom attachable to said wire control assembly top;
wherein said connector unit is removably connectable to a light source module of said lighting system.

52. The connector unit of claim 51, further including a plurality of sleeves, wherein one of said sleeves mounts one of said connection posts to one of said wires.

53. The connector unit of claim 51, wherein said wire control assembly bottom and said wire control assembly top include an analogous set of grooves accommodating said wires.

54. The connector unit of claim 51, wherein said wire control assembly bottom and said wire control assembly top are permanently attached to each other.

55. A method for lighting, comprising the steps of:
a) providing a lighting system including an electrically continuous wiring harness and a plurality of light source modules electrically connected with said wiring harness, wherein each light source module includes at least one light source unit having a cluster of a plurality of light emitting diodes, wherein said light source module may be disconnected from said connector unit in the absence of interrupting an electrical connection of the wiring harness;
b) positioning said lighting system with respect to said surface;
c) emitting light from said light source modules, and
d) independently controlling a relative intensity of the light emitted from each light emitting diode included in a light source unit of said light source module.

56. (canceled)

57. The method for lighting of claim 55, further including the step of providing a combined light emission of a desired color and intensity from all of said light emitting diodes included in said light source unit.

58. The method for lighting of claim 55, further including the step of mounting said lighting system to provide indirect illumination of said surface.

59. The method for lighting of claim 55, further including the step of mounting said lighting system to provide illumination to a space.

60. The method for lighting of claim 55, further including the step of providing a controlled color nixing design.

61. (canceled)

62. (canceled)
